(19) United States
(12) Patent Application Publication
(10) Pub. No.: US 2009/0213217 A1
(43) Pub. Date: Aug. 27, 2009

(54) SECURITY CAMERA CAPABLE OF PREVENTING SPIDERS

(75) Inventor: Yoon Hwa Ko, Bucheon-si (KR)

Correspondence Address: Workman Nydegger;1000 Eagle Gate Tower, 60 East South Temple, Salt Lake City, UT, 84111, US

(73) Assignee: HDPRO CO., LTD., Bucheon-si (KR)

(21) Appl. No.: 12/253,585

(22) Filed: Oct. 17, 2008

(30) Foreign Application Priority Data
Feb. 22, 2008 (KR) 10-2008-0016246

(51) Int. Cl. H04N 7/18

(52) U.S. Cl. 348/143; 348/E07.085

(57) ABSTRACT

A security camera capable of preventing spiders by generating frequencies that pest or spiders detest, includes a key input part for inputting and setting condition of temperature and humidity and controlling ON/OFF operation, an ultrasonic wave generating part for generating ultrasonic waves and outputting the same via speakers, a humidity detecting part for controlling signals transmitted from a humidity sensor, a temperature detecting part for controlling signals transmitted from a temperature sensor, and a display part for displaying the generation of the ultrasonic waves, wherein a microprocessor drives the ultrasonic wave generating part to output the ultrasonic waves in the frequencies of 20,000˜50,000 Hz as the humidity detecting part and the temperature detecting part reach the set values thereof, thereby preventing spiders' webs around the security camera and obtaining clear images for a monitoring section.

### CROSS-REFERENCE TO RELATED APPLICATIONS

This application claims the benefit of Korean Patent Application No. 10-2008-0016246, filed on Feb. 22, 2008, entitled “Security Camera Capable of Preventing Spiders”, which is incorporated herein by reference.

### BACKGROUND OF THE INVENTION

1. The Field of the Invention

The present invention relates to a security camera capable of preventing spiders, and more particularly to a security camera capable of preventing spiders so as to always obtain clear images of a monitoring area by exterminating spiders which would like to settle in front of or in a blind of the camera and spider webs for obtaining food.

2. The Relevant Technology

In general, security cameras are mounted in places requiring security for monitoring visitors at homes, in commercial establishments, plants, hospitals, banks and the like, wherein such a security camera is used in various types such as straight type, dome type and the like according to the place where the security camera is mounted or the purpose of the security camera.

In such a prior art security camera, even though images of a subject photographed in a visible ray area in the daytime or in an area which is dark but mounted with illumination devices have good discrimination, those obtained under the low intensity of illumination such as in a dark area such as a basement having no illumination in the nighttime are not clear so that IR LEDs are employed to light the dark area to photograph the subject under the improved intensity of illumination.

In a security camera mounted with the IR LEDs, a plurality of IR LEDs are disposed around or at a side of a camera module and light generated from the IR LEDs is radiated to a subject which is incident upon a lens. Even though the light generated by the IR LEDs is invisible, the light has high transmissivity and carries out thermal action of high degree.

In the case of such a security camera having the IR LEDs and a blind, the light is radiated to a subject via a protection glass or a transparent cover, which is mounted at a front surface of a lens part, increasing the temperature of the camera through the contact between the light and peripheral parts, the protection glass or the transparent cover, and the blind blocks external light, inducing the dark environment.

The prior art security camera mounted under a ceiling or in the corner between walls of a room, a living room, an office and the like as described above satisfies proper condition for spiders to settle or act, for example, the temperature of 22˜30° C., the darkness, and the relative humidity of 55˜85%. Therefore, the spiders spin the webs on the front surface of the lens part of the security camera and in the blind of the security camera to obtain food while settling there. Thus, the spiders, the webs and insects caught in the spiders' webs make the images photographed from a monitoring area vague, so that the recognition of the photographed images becomes difficult.

### BRIEF SUMMARY OF THE INVENTION

Therefore, the present invention is derived to resolve the above and other disadvantages of the prior art, and an object of the invention is to provide a security camera capable of preventing spiders, which automatically generates ultrasonic waves in the frequencies that pest such as spiders detest so as to prevent the spiders as proper condition for the spiders to settle or obtain food is realized.

In order to achieve the above objects, according to the present invention, there is provided a security camera capable of preventing spiders by generating ultrasonic waves in the frequencies that pest or spiders detest, which includes a key input part for inputting and setting condition of temperature and humidity and controlling ON/OFF operation; an ultrasonic wave generating part for generating ultrasonic waves according to predetermined control signals in a storing mode set via the key input part and outputting the generated ultrasonic waves via speakers; a humidity detecting part for controlling signals transmitted from a humidity sensor; a temperature detecting part for controlling signals transmitted from a temperature sensor; and a display part for displaying whether the ultrasonic waves that the pest detest are generated or not, wherein a microprocessor drives the ultrasonic wave generating part to output frequencies in the range of 20,000˜50,000 Hz if the humidity detecting part and the temperature detecting part reach the set values thereof when a user turns on the key input part.

Further, the security camera capable of preventing spiders according to the present invention is characterized in that the temperature sensor and the humidity sensor are exposed above a front end of the security camera which is adjacent to the inside of the blind, which is dark so that spiders can spin webs easily.

According to the security camera of the present invention as described above, if a user sets an ultrasonic wave generating mode via the key input part, the frequencies of 20,000˜50,000 Hz that the spiders detest are automatically generated via the speakers to prevent the spiders as the proper temperature and humidity condition for the spiders to settle or obtain food is realized. Therefore, it becomes possible to prevent the spiders' webs in front of the lens part and in the blind of the camera and to obtain clear images of a monitoring area with high discrimination.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

The objects, features and advantages of the present invention will be more clearly understood from the following detailed description in conjunction with the accompanying drawings, in which:

FIG. 1 is a side view showing a security camera capable of preventing spiders according to the present invention; and

FIG. 2 is a block diagram showing the function of preventing spiders according to the present invention.

### DETAILED DESCRIPTION OF THE PREFERRED EMBODIMENTS

Now, a security camera capable of preventing spiders according to a preferred embodiment of the present invention will be described in more detail in the structure and operation thereof with reference to the accompanied drawings.

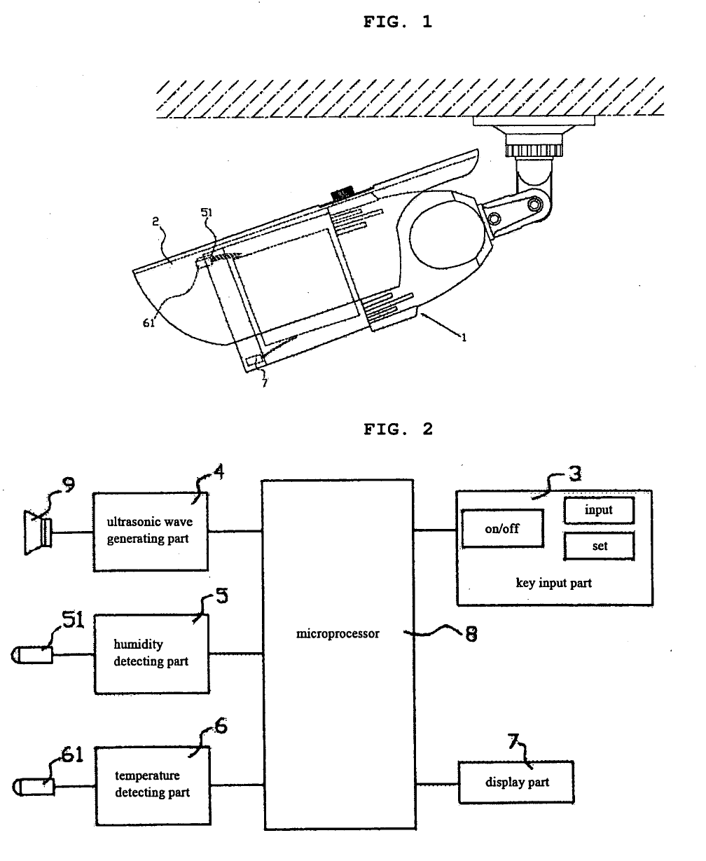

FIG. 1 is a side view showing a security camera capable of preventing spiders according to the present invention, and FIG. 2 is a block diagram showing the function of preventing spiders according to the present invention. In FIG. 1 and FIG. 2, reference symbol 1 indicates the security camera, reference symbol 2 indicates a blind, reference symbol 3 indicates a key input part which is exposed to the outside of the security camera 1 for a user to input or set condition such as temperature or humidity and to control the on/off operation of ultrasonic wave generating mode, reference symbol 4 indicates an ultrasonic wave generating part disposed in the security camera 1 for generating ultrasonic waves to be output via speakers 9 according to a predetermined control signal in a storing mode set via the key input part 3, reference symbol 5 indicates a humidity detecting part disposed in the security camera 1 for controlling signals transmitted from a humidity sensor 51, reference symbol 6 indicates a temperature detecting part disposed in the security camera 1 for controlling signals transmitted from a temperature sensor 61, reference symbol 7 indicates a display part disposed in the security camera to be seen outside the security camera 1 for displaying whether the ultrasonic waves that the pest detest are generated or not, and reference symbol 8 indicates a microprocessor disposed in the security camera 1 for controlling all of the above operation to drive the ultrasonic wave generating part 4 to output the frequencies of 20,000˜50,000 Hz via the speakers 9 as the humidity detecting part 5 and the temperature detecting part 6 reach set values thereof respectively when the user manipulates the key input part 3.

In the security camera 1, the front end of the security camera 1 is adjacent to a dark inside of the blind 2 where the spiders are good to settle or spin webs for obtaining food, and the temperature sensor 61 and the humidity sensor 51 are disposed on the front end of the security camera 1 to be exposed to the outside.

Now, the operation of the security camera capable of preventing spiders according to the present invention as described above will be explained in more detail.

First, while a common security camera 1 having IR LEDs and additionally provided with the spider preventing function of the present invention, a user pushes an ON/OFF button of the key input part 3 for power supply and then the user inputs and sets the temperature of 22˜30° C. and the relative humidity of 55˜85% as the proper condition for the spiders to act.

The security camera 1 is surrounded by the blind 2 which blocks the external light, so that the security camera 1 is in the state darker than the outside. An IR lamp is turned on in the nighttime, so that the proper condition for the spiders, that is, the temperature of 22˜30° C. and the relative humidity of 55˜85% to act may be realized around the security camera 1 by the IR lamp.

As the humidity detecting part 5 and the temperature detecting part 6 detect the proper condition for the spiders to settle or obtain food through the input signals from the humidity sensor 51 and the temperature sensor 61, the humidity detecting part 5 and the temperature detecting part 6 output signals for the proper condition to the microprocessor 8. Then, the microprocessor 8 realizes the ultrasonic wave generating mode, so that the display part 7 is lighted and simultaneously the ultrasonic wave generating part 4 receives a control signal from the microprocessor 8. Next, the ultrasonic wave generating part 4 is driven according to the control signal output from the microprocessor 8, and generates the frequencies of 20,000˜50,000 Hz that the pest such as cockroaches, flying insects, wasps, moths, spiders and the like detest most for outputting the frequencies via the speakers to prevent the pest and spiders.

The ultrasonic wave generating mode is kept continuously under the proper condition for the spiders and the ultrasonic waves that the spiders detest are output via the speakers continuously, so that the pest and the spiders are prevented from approaching the security camera 1 in advance. Therefore, clear images may be obtained via the security camera 1 all the time.

To the contrary, as the humidity detecting part 5 and the temperature detecting part 6 receive the signals from the humidity sensor 51 and the temperature sensor 61 under improper condition for the spiders, the humidity detecting part 5 and the temperature detecting part 6 transmit signals for the improper condition to the microprocessor 8 so that the microprocessor 8 finishes the ultrasonic wave generating mode.

The operation of the ultrasonic wave generating mode is controlled according to the signal condition input to the microprocessor 8, wherein the ultrasonic wave generating mode may be realized when all or anyone of the proper temperature and the proper humidity for the spiders is realized as the proper condition for the spiders, while the ultrasonic wave generating mode is stopped in any other cases. The humidity sensor 51 and the temperature sensor 61 are disposed in the dark inside of the blind 2 where the optimum condition for the spiders is realized for settling or obtaining food, as shown in FIG. 1. Therefore, it is more effective to prevent the spiders from approaching the security camera 1.

Although the foregoing description has been made with reference to the preferred embodiment, it is to be understood that changes and modifications of the present invention may be made by the ordinary skilled in the art without departing from the spirit and scope of the present invention and appended claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A security camera capable of preventing spiders by generating frequencies that pests or spiders detest, comprising:
a key input part for inputting and setting condition of temperature and humidity and controlling ON/OFF operation;
an ultrasonic wave generating part for generating ultrasonic waves according to predetermined control signals in a storing mode set via the key input part and outputting the generated ultrasonic waves via speakers;
a humidity detecting part for controlling signals transmitted from a humidity sensor;
a temperature detecting part for controlling signals transmitted from a temperature sensor; and
a display part for displaying whether the ultrasonic waves that the pest detest are generated or not,
wherein a microprocessor drives the ultrasonic wave generating part to output frequencies in the range of 20,000˜50,000 Hz if the humidity detecting part and the temperature detecting part reach the set values thereof when a user turns on the key input part.

2. The security camera as claimed in claim 1, wherein the temperature sensor and the humidity sensor are exposed above a front end of the security camera which is adjacent to the inside of a blind, which is dark so that spiders can spin webs easily.
